(19) United States
(12) Patent Application Publication
(10) Pub. No.: US 2018/0369874 A1
(43) Pub. Date: Dec. 27, 2018

(54) LIQUID DISPENSING CONTAINER AND CLEANING ROBOT

(71) Applicant: Suzhou Radiant Photovoltaic Technology Co., Ltd., Suzhou (CN)

(72) Inventors: Jiayong JIANG, Suzhou (CN); Changsheng JIANG, Suzhou (CN); Jianrong XU, Suzhou (CN)

(73) Assignee: Suzhou Radiant Photovoltaic Technology Co.,Ltd., Suzhou (CN)

(21) Appl. No.: 15/743,682

(22) PCT Filed: Jan. 26, 2017
(86) PCT No.: PCT/CN2017/072759

§ 371 Date: Jan. 11, 2018

(51) Int. Cl. B08B 1/04; B08B 1/00; B08B 13/00; H02S 40/10

(52) U.S. Cl. CPC B08B 1/04; H02S 40/10; B08B 13/00; B08B 1/002

(57) ABSTRACT

A liquid dispensing container and cleaning robot are provided. The cleaning robot includes the liquid dispensing container, the liquid dispensing container includes a column-shaped portion; a taper portion having a bottom surface connected to a lower bottom surface of the column-shaped portion; and a drainage outlet disposed on a top point of the taper portion; wherein the liquid dispensing container is disposed on a sloping plane; an included angle between a side surface of the taper portion and the bottom surface of the taper portion is greater than or equal to an included angle between a sloping plane and a level surface.

### FIELD OF INVENTION

The present invention relates to cleaning robot fields, especially to a liquid dispensing container and a cleaning robot.

### BACKGROUND OF INVENTION

As fossil fuels are in a decline, new renewable solar energy has become an important part of energy used by humans, as solar energy technology has been rapidly developed in all countries in the world over the past decade. A solar panel refers to a device that converts solar energy directly into electrical energy using semiconductor materials that generate photovoltaic (PV) effect when exposed to sunlight. The solar panels are suitable for applications ranging from large power stations to small portable chargers. In recent years, the solar panels have had rapid development.

Work environment of the solar panels can only be outdoors, where a biggest problem affecting their work is not thunderstorms but dust that has accumulated over the years. The dust or other adhesion attached to the solar panel may affect light transmittance of the panel and limit photoelectric efficiency, which will seriously affect efficiency of the panel directly obtaining the sunlight, reduce panel energy absorption and conversion efficiency, and reduce power generation efficiency.

Conventional solar panels in use can only rely on regular completion of manual cleaning work. Because of larger solar panels, large power stations use more panels at the same time, dust will be accumulated repeatedly, and repeated cleaning is required. Therefore, labor costs are high, cleaning efficiency is low, and cleaning effect is poor. In many occasions, in order to improve space utilization rate, solar panels are set in high places by mounting brackets, which brings more difficulty and risks for cleaning. In order to reduce cleaning costs, many users of the solar panels can only choose not to clean, and therefore can only be forced to bear the power loss caused by dust. Thus, a new automatic cleaning device is needed for automatic cleaning the solar panels.

Conventional cleaning robots can only be applied to level surfaces instead of being applied to sloping planes of the solar panels. Applying the conventional cleaning robots directly to the solar panels will result in the following issues.

(1) The cleaning robot has insufficient mobility and cannot move freely. The cleaning effect is poor. Since the tilt angle of the solar panel is generally from 10 to 40 degrees, the conventional cleaning robot cannot freely move on the sloping plane and will soon run out of power.

(2) The cleaning robot may slide and fall down from the solar panel. Because the solar panel is relatively smooth, weight of the conventional cleaning robot and friction coefficient of the wheel are relatively low, the friction force is relatively low, and the moving robot moves with difficulty and slips easily.

(3) The cleaning robot cannot follow the prescribed route, move in a small coverage area, and may fall from an edge of the solar panel. The conventional cleaning robot is generally set to automatically turn and bypass obstacles encountered. Because the solar panel does not have any obstacles, the automatically moving cleaning robot can only moving on a single path, its coverage area during moving is small and the cleaning robot will inevitably fall from the edge of the solar panel. Even with a pre-planned path, existing cleaning robots, during moving, are susceptible to gravity and the panel attachments can also easily deviate from the path, making it difficult to ensure straight-line travel. Furthermore, the cleaning robot itself cannot detect and cannot move through the entire panel, which leaves a lot of room for cleaning.

(4) Recharging the cleaning robot is difficult. Since the solar panel is relatively high and is large in area, it is more difficult to remove the cleaning robot therefrom once the cleaning robot has been set up. In the prior art, manually removing the cleaning robot from the site or manually removing the battery the cleaning robot and then charging it is necessary, which makes the cleaning robot unable to be sustained on-site operations for a long time. Moreover, because many of the solar panel are set high with the bracket, so charging operation is very troublesome and wasting a lot of manpower.

(5) Monitoring a working status of the cleaning robot is difficult. As the solar panel may be set high, a staff member on the ground cannot monitor the whole process. Even though the cleaning robot fails, stops to operate or deviates from the route, a staff member is unable to be aware of it in time.

To further enhance the cleaning effect, the liquid dispensing container needs to be set in the cleaning robot to provide detergent solution and water to the cleaning roller brush. Since the cleaning robot is applied to the sloping plane of the solar panel, if the cleaning device in the liquid dispensing container can utilize an ordinary cylindrical water tank or cuboid water tank, no matter how the drainage outlet is set, there is no guarantee for the drainage outlet to be always in the lowest container. Under some angles, when liquid in the liquid dispensing container becomes less, the liquid level may be lower than the drainage outlet such that part of the liquid cannot be discharged smoothly. Because photovoltaic panels are often set up in high places, it is difficult to replenish or replace the liquid dispensing container. Therefore, each drop should be used reasonably. The present invention needs a specially shaped liquid dispensing container designed to ensure that the liquid in the container can be adequately extracted regardless of the direction the robot moving toward (uphill, downhill or horizontally moving).

### SUMMARY OF INVENTION

An objective of the present invention is to provide a liquid dispensing container to solve the technical issue that a conventional container cannot discharge all the liquid when moving on the sloping plane.

To solve the above issue, the present invention provides a liquid dispensing container including a column-shaped portion; a taper portion having a bottom surface connected to a lower bottom surface of the column-shaped portion; and a drainage outlet disposed on a top point of the taper portion; wherein the liquid dispensing container is disposed on a sloping plane; an included angle between a side surface of the taper portion and the bottom surface of the taper portion is greater than or equal to an included angle between the sloping plane and a level surface.

Furthermore, the liquid dispensing container further includes a container cover securely installed on an upper bottom surface of the column-shaped portion; a fill inlet extending through the container cover; a fill inlet lid detachably installed on the fill inlet; and a bidirectional pressure relief valve installed through the fill inlet lid.

Furthermore, the liquid dispensing container is a sealing container.

Furthermore, the column-shaped portion is a cylinder, the taper portion is a cone, and a bottom surface of the cone is a lower bottom surface of the cylinder; or the column-shaped portion is a prism, the taper portion is a pyramid, a pyramid-bottom-surface of the pyramid is a lower bottom surface of the prism.

Furthermore, the liquid dispensing container further includes a liquid level sensor configured to acquire liquid level information in the liquid dispensing container.

Furthermore, the bidirectional pressure relief valve includes a valve body; a valve chamber disposed in the valve body; a sealing valve block slidably installed in the valve chamber; and a sealing stopper protruding from a middle portion of an inner sidewall of the valve chamber; wherein a sidewall of a widest portion of the sealing valve block is disposed tangentially to a sidewall of the sealing stopper and the inner sidewall of the valve chamber.

Furthermore, the sealing valve block includes an annular shoulder portion protruding from a middle portion of a sidewall of the sealing valve block; and a sidewall of the annular shoulder portion is disposed tangentially to the sidewall of the sealing stopper and the inner sidewall of the valve chamber.

Furthermore, the bidirectional pressure relief valve further includes a first vent hole disposed on a top portion of the valve body; and a second vent hole disposed on a bottom surface of the valve body.

Furthermore, the bidirectional pressure relief valve further includes a first resilient element having an upper end securely disposed on a top portion of the valve chamber and a lower end connected to the sealing valve block; and a second resilient element having an upper end connected to the sealing valve block and a lower end securely disposed on a bottom portion of the valve chamber.

Another objective of the present invention is to provide a cleaning robot to solve the technical issue that a conventional container cannot discharge all the liquid when moving on the sloping plane.

To solve the above issue, the present invention provides a cleaning robot disposed on a sloping plane and including the cleaning device as described above.

Advantage of the present invention is that the liquid dispensing container of the present invention can ensure to discharge all inside liquid out during the moving of the sloping plane. No matter what direction the cleaning robot utilizing the liquid dispensing container moves toward one the slope, it is guaranteed that water or detergent solution in the robot can be fully utilized to efficiently enhance cleaning effect and reduce waste of water or detergent solution.

### DESCRIPTION OF DRAWINGS

FIG. 1 is an overall appearance schematic view of a cleaning robot of an embodiment of the present invention;

FIG. 2 is an internal structure schematic view of the cleaning robot of the embodiment of the present invention;

FIG. 3 is an exploded structure schematic view of the cleaning robot of the embodiment of the present invention;

FIG. 4 is a structure schematic view of a cleaning device of the embodiment of the present invention;

FIG. 5 is another structure schematic view of the cleaning device of the embodiment of the present invention;

FIG. 6 is a bottom structure schematic view of a liquid dispensing container of the embodiment of the present invention;

FIG. 7 is a structure schematic view of the working status of the liquid dispensing container of the embodiment of the present invention on a slope;

FIG. 8 is a structure schematic view of the liquid dispensing container of the embodiment of the present invention;

FIG. 9 is another structure schematic view of the liquid dispensing container of the embodiment of the present invention;

FIG. 10 is a cross sectional structure schematic view of the liquid dispensing container of the embodiment of the present invention;

FIG. 11 is a structure schematic view of a liquid level sensor of the embodiment of the present invention;

FIG. 12 is a cross sectional structure schematic view of a fill inlet lid of the embodiment of the present invention;

FIG. 13 is a cross sectional structure schematic view of a bidirectional pressure relief valve of the embodiment of the present invention; and

FIG. 14 is a structural block diagram of a control system of the embodiment of the present invention.

The reference numerals in the figures are as follows:

100 solar panel cleaning robot/cleaning robot/ robot, 200 solar panel, 300 sloping plane, 400 server;

1 robot body, 2 cleaning device, 3 power system, 4 control system, 5 electric power system; 11 body member;

21 cleaning motor, 22 roller brush, 23 transmission mechanism, 24 debris baffle, 25 liquid dispensing container, 26 nozzle head, 27 forked pipe, 28 water pump;

41 data acquisition unit, 42 processor, 43 storage unit, 44 alarm unit, 45 wireless communication unit; 51 battery box;

211 cleaning motor shaft, 221 roller brush driven shaft, 231 driving gear, 232 driven gear, 233 double gear;

251 drainage outlet, 252 column-shaped portion, 253 taper portion, 254 container cover, 255 fill inlet, 256 fill inlet lid, 257 bidirectional pressure relief valve, 258 annular lid opening, 259 liquid level sensor;

261 nozzle, 271 main pipe;

411 accelerometer sensor, 412 magnetic sensor, 413 distance sensor, 414 counter, 415 image sensor;

2331 large gear ring, 2332 small gear ring;

2541 connection slot hole, 2591 longitudinal rod, 2592 float sensor, 2593 disc-shaped connector, 2594 annular block, 2595 wire;

2571 valve body, 2572 valve chamber, 2573 sealing valve block, 2574 sealing stopper, 2575 first vent hole, 2576 second vent hole, 2577 first resilient element, 2578 second resilient element, 2579 annular shoulder portion.

### DETAILED DESCRIPTION OF PREFERRED EMBODIMENTS

A preferred embodiment of the present invention will be introduced with reference to appended figures as follows to demonstrate that the present invention may be implemented. The embodiment of the present invention can be fully introduced to those skilled in the art to make technical contents more clear and easy to understand. The present invention can be embodied in many different forms of embodiment, and the scope of protection of the present invention is not limited to the embodiments set forth herein.

In the appended figures, structurally identical components are designated by the same reference numerals, and structurally or functionally similar components throughout are designated by similar numerical reference numerals. The dimensions and thicknesses of each component shown in the figures are arbitrarily shown. The size and thickness of each component are not limited, and for the sake of clarity, the thickness of the components is exaggerated somewhat in some places in the figures.

Direction terms mentioned by the present invention, for example “upper”, “lower”, “front”, “rear”, “left”, “right”, “inner”, “outer”, “side”, etc. are merely directions in the appended figures for only explaining and illustrating the present invention but not to limit the protection scope of the present invention.

When some part is described to be “on” another part, the part may be directly disposed on the other part; alternatively, an intervening part may exist, the part is disposed on the intervening part, and the intervening part is disposed on the other part. When a part is described to be “installed on” or “connected to” another part, it may be understood that the parts are directly “installed” or “connected” to each other, alternatively it is understood that one part is “installed” or “connected” to the other part through an intervening part.

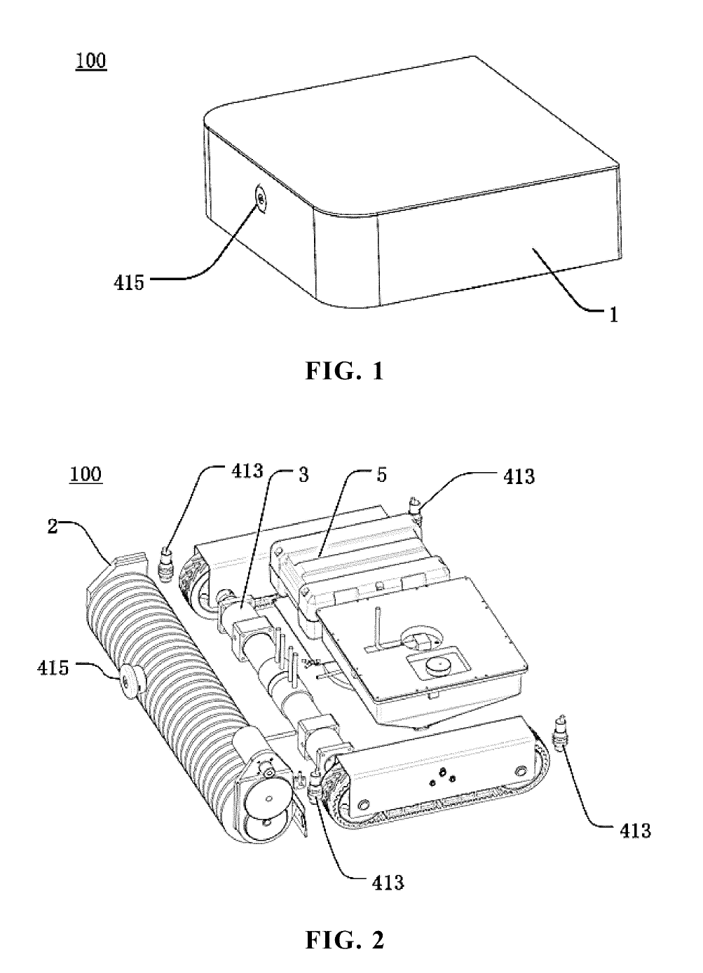

With reference to FIGS. 1 to 3, the present invention provides a solar panel cleaning robot 100 (abbreviated as “cleaning robot” or “robot” hereinafter) comprising a robot body 1. The robot body 1 can move on at least one solar panel. A cleaning device 2, a power system 3, a control system 4 and an electric power system 5 are disposed on an external or an internal of the robot body 1.

The cleaning device 2 is configured to clean solar panel during moving of the robot body. The power system 3 is configured to adjust a moving direction and a moving speed of the robot body 1 on the solar panel, and to control the robot body 1 to move, stop or turn; the control system 4 is connected to the power system 3 and the cleaning device 2, and is configured to transmit various control signals to the power system 3 and the cleaning device 2. The electric power system 5 is connected to the power system 3, the cleaning device 2 and the control system 4, and is configured to provide the power system 3, the cleaning device 2 and the control system 4 with electricity.

During normal work of the solar panel cleaning robot 100 of the present invention on the solar panel, when the electric power system 5 is switched on, the control system 4 transmits at least one moving control instruction and at least one cleaning control instruction, the power system 3, according to the moving control instruction, controls the robot body 1 to move along a pre-planned path. In the meantime, the cleaning device 2 switches on the cleaning device 2 according to the cleaning control instruction to clean the solar panel. During moving of the robot body 1, the control system 4 transmits multiple moving control instructions, such as deflection correction instruction, turn instruction and U-turn instruction, etc. to the power system 3 to command the robot body 1 to return to an original path in the case of deflection of straight path, i.e. deflection correction. Alternatively, under a certain condition or a certain place, a turn or U-turn (turning back) is performed such that the robot body 1 is driven to move according to a pre-planned optimized path. Specific navigation methods, deflection correction methods and turn or U-turn (turning back) controlling methods for the robot body will be described in detail below. During the entire moving process, no matter what moving mode the robot body 1 proceeds with, such as straight moving, deflection, deflection correction, turn or U-turn, the cleaning device 2 always remains in working status. When the control system 4, based on certain working parameters (for example, the pre-planned path is finished, or the electric power system 5 has insufficient power), transmits a moving control instruction to stop moving, the robot body 1 stops moving; meanwhile, the control system 4 transmits a cleaning control instruction to switch off the cleaning device 2 to stop cleaning.

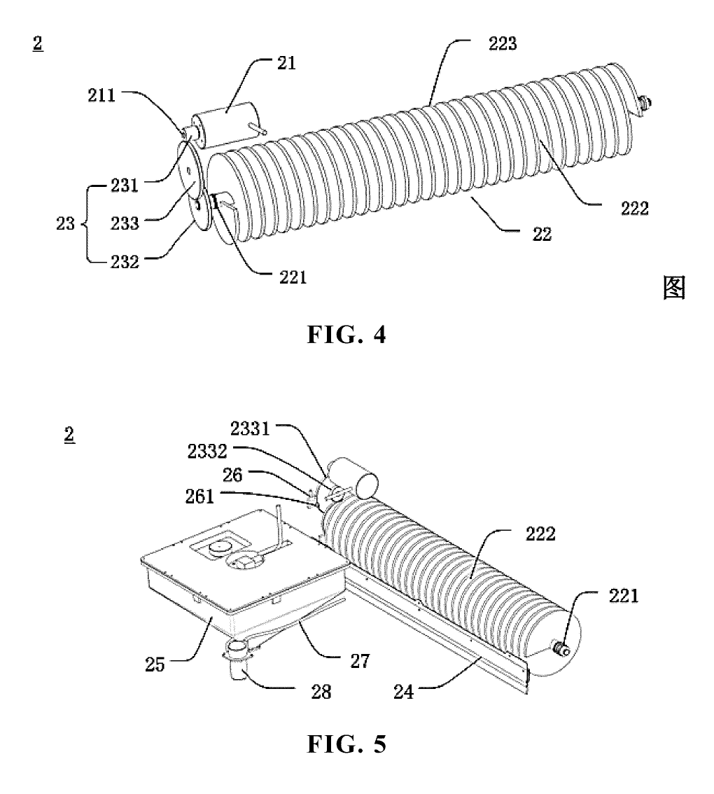

With reference to FIG. 4, the cleaning device 2 of the present invention includes a cleaning motor 21, a roller brush 22 and a transmission mechanism 23.

With reference to FIGS. 4 and 5, in the present invention, the cleaning motor 21 includes a cleaning motor shaft 211. A roller brush driven shaft 221 is disposed on a center of the roller brush. The transmission mechanism 23 is simultaneously connected to the cleaning motor shaft 211 and the roller brush driven shaft 221, the cleaning motor shaft 211 drives the roller brush driven shaft 221 to rotate through the transmission mechanism 23. The roller brush 22 is disposed a lower portion of a front end of the robot body 1. A lower end of the roller brush 22 directly contacts the solar panel for cleaning the solar panel.

The transmission mechanism 23 is a gear set composed of two or more large and small gears engaged with each other, and is configured to transmit power of the cleaning motor shaft 211 to the roller brush driven shaft 221 while decreasing the rotating speed output by the cleaning motor 21 such that the roller brush 22 is driven to rotate by the slower rotating speed. In the present invention, the transmission mechanism 23 includes a driving gear 231, a driven gear 232 and a double gear 233. The driving gear 231 is disposed on the cleaning motor shaft 211. The cleaning motor shaft 211 is perpendicular to a gear surface of the driving gear 231. The driven gear 232 is disposed on the roller brush driven shaft 221. The roller brush driven shaft 221 is perpendicular to a gear surface of the driven gear 232. The roller brush driven shaft 221 parallels the cleaning motor shaft 211. The double gear 233 includes a large gear ring 2331 and a small gear ring 2332 that are integrally formed together. The large gear ring 2331 is engage with the driving gear 231. The small gear ring 2332 is engaged with the driven gear 232. When the cleaning motor 21 is switched on, the cleaning motor shaft 211 rotates at high speed. After deceleration process by the double gear 233, the roller brush driven shaft 221 drives the roller brush 22 to rotate with a slower speed such that the roller brush 22 can clean the solar panel. A rotating speed ratio of the cleaning motor shaft 211 and the roller brush driven shaft 221 depends on a radius ratio of the large gear ring 2331 and the small gear ring 2332.

The roller brush 22 is a helical roller brush, the helical roller brush includes at least one helical blade 222, the helical blade 222 may have multiple sheet-like bladelets 223. The bladelets 223 are equally spaced apart from one another such that the roller brush 22 and the solar panel fully contact each other, and the parts of the solar panel on which the robot body 1 have passed through can be cleaned. During the moving of the robot body 1 of the present invention, the roller brush 22 constantly cleans attachments such as dust on the solar panel.

With reference to FIG. 5, the cleaning device 2 further includes a debris baffle 24 securely installed on a side surface of the roller brush 22. The roller brush driven shaft 221 in the center of the roller brush 22 parallels the debris baffle 24. With reference to FIG. 2, the cleaning device 2 is disposed on a front end (i.e. front portion of the robot body) of the cleaning robot 100. A rear end (i.e. rear portion of the robot body) of the cleaning robot 100 includes a body member 11. The debris baffle 24 is disposed between the cleaning device 2 and body member 11. During the cleaning, the debris baffle 24 can effectively collect dust, debris, sewage and other debris together to easily remove them from the surface, and can prevent debris from entering the cleaning device 2 or the power system 3 to protect parts in the robot body 1 from damages.

With reference to FIG. 5, the cleaning device 2 further includes a liquid dispensing container 25, at least one nozzle head 26 and a forked pipe 27.

With reference to FIGS. 5 to 10, the liquid dispensing container 25 (may be abbreviated as “container 25”) is a detachable sealing container for storing water or detergent solution, and a drainage outlet is disposed on a bottom of the liquid dispensing container 25. The nozzle head 26 is disposed on an upper portion or a side portion of the roller brush 22. Each nozzle head 26 includes a nozzle, and the nozzle faces the roller brush 22. The forked pipe 27 includes a main pipe and at least one branch pipe (not shown in the figures) communicating with each other. The main pipe 271 communicates with the drainage outlet. Each branch pipe communicates with one nozzle head 26. In the present invention, two nozzle heads 26 are preferably disposed respectively on two ends of the roller brush 22, the nozzles face the roller brush 22. The forked pipe 27 is preferably a forked pipe including one main pipe 271 and two branch pipes, and conveys the water or detergent solution in the liquid dispensing container 25 to the two nozzle heads 26.

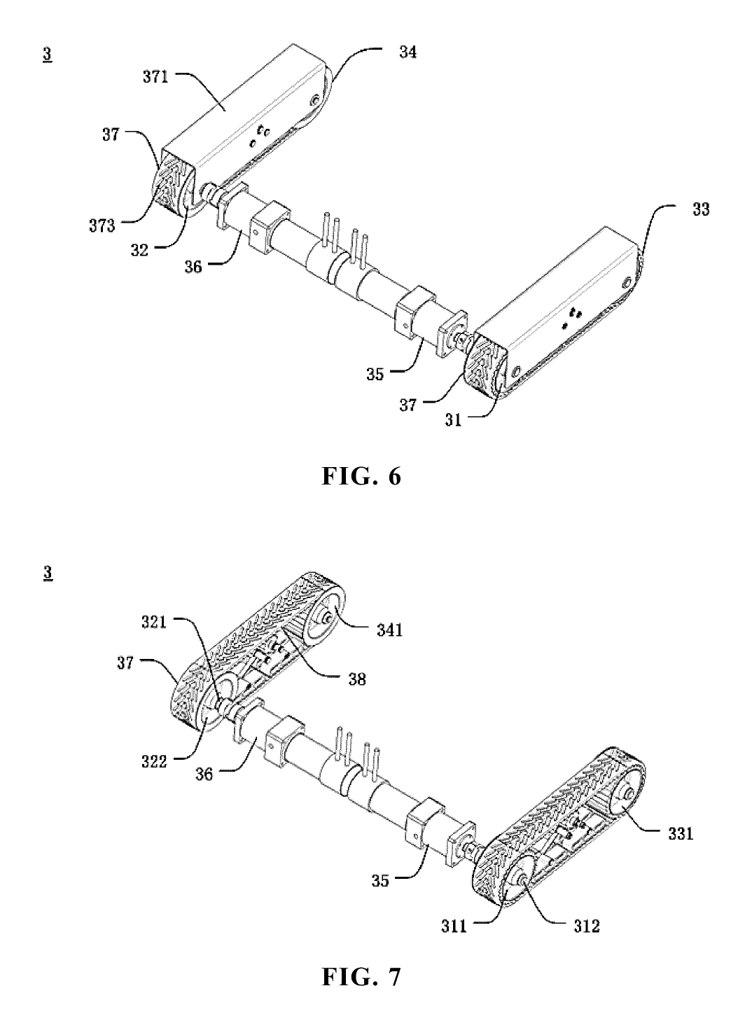

With reference to FIGS. 5 and 6, the cleaning device 2 further includes a water pump 28 connected to the control system 4 and acquiring at least one water pump control signal from the control system 4. The water pump 28 is disposed on the main pipe 271, and serves as a switch for controlling the liquid dispensing container 25 to discharge liquid and adjusting discharging speed of liquid according to the water pump control signal.

In the present invention, during the roller brush 22 cleaning the solar panel 200, the control system 4, according to requirement, transmits at least one water pump control signal to the water pump 28, switches on the water pump 28 and adjusting water-pumping speed to make the water or detergent solution in the liquid dispensing container 25 flow out to the nozzle head 26 through the forked pipe 27 and form tiny liquid droplets being radially sprayed to the roller brush 22 such that the sprayed liquid falls on the roller brush 22 as evenly as possible. The rotating roller brush 22 drives the water or detergent solution to fall on the solar panel 200 while the roller brush 22 is used to clean the solar panel 200, which can effectively enhance the decontamination effect. When there is no enough remaining liquid in the liquid dispensing container 25 or the electric power of the electric power system is insufficient, or when cleaning work is finished, the control system 4 transmits a stop-pumping control signal to the water pump 28 to switch off the water pump 28. A method for determining remaining liquid in the liquid dispensing container 25 and a method for determining remaining electric power of the electric power system 5 will be described in detail below.

In the present invention, the technical effect of the cleaning device 2 lies in that the cleaning work to the solar panel 200 can be finished during the moving of the cleaning robot 100. If necessary, water or detergent solution can be sprayed on the solar panel to be treated to better remove stubborn stains. The cleaning device 2 has fast cleaning speed and excellent effect, which can reduce labor cost effectively without manual monitoring or assistance.

Because the cleaning robot provided by the present invention is applied to the sloping plane like the solar panel, if the liquid dispensing container in the cleaning device can utilize a general cylindrical water tank or cuboid water tank, no matter how the drainage outlet is disposed, there is no guarantee for the drainage outlet to be at the lower point of the container. Under some angles, when liquid in the liquid dispensing container becomes less, the liquid level may be lower than the drainage outlet such that part of the liquid cannot be discharged smoothly. Because some solar panels are set in high places, replenishing the cleaning robot with liquid is troublesome. Therefore, liquid in the liquid dispensing container needs to be discharged out as completely as possible for full use. Thus, a designing a special shape for the liquid dispensing container 25 is required to ensure that the liquid in the container can be adequately extracted regardless of the direction the robot moving toward (uphill, downhill or horizontally moving).

With reference to FIGS. 5 to 10, the present invention provides a liquid dispensing container 25 (abbreviated as “container”) configured to dispense liquid on a sloping plane. During the moving of the solar panel cleaning robot on the solar panel, the liquid dispensing container 25 in the robot body can dispense liquid. The liquid dispensing a body of the container 25 is a well-sealed container and mainly includes a column-shaped portion 252 and a taper portion 253 connected to each other. A bottom portion of the taper portion 253 is upside down below the column-shaped portion 252. A bottom surface of the taper portion 253 connected to a lower bottom surface of the column-shaped portion 252. A drainage outlet 251 is disposed on a top point at the lowest portion (cone tip) of the taper portion 253.

With reference to FIG. 7, to make liquid in the liquid dispensing container 25 to be fully extracted out, when the liquid dispensing container 25 move toward any direction on the sloping plane 300, the drainage outlet 251 should be ensured to be always at the lowest point of the liquid dispensing container 25. Therefore, an included angle between a side surface of the taper portion 253 and the bottom surface of the taper portion 253 is greater than or equal to an included angle between the sloping plane 300 and a level surface. In the present invention, the solar panel 200 is the sloping plane 300. To ensure that when the liquid dispensing container 25 moves toward any direction on the solar panel 200, the drainage outlet 251 is always at the lowest point of the liquid dispensing container 2, the included angle between the side surface of the taper portion 253 and the bottom surface of the taper portion 253 is greater than or equal to the included angle between the solar panel 200 and the level surface, i.e. the tilt angle of the solar panel 200. Because the tilt angle of the solar panel 200 is generally from 10 to 40 degrees, a range of the included angle between the side surface of the taper portion and the bottom surface of the taper portion is generally from 15 to 45 degrees. Because the greater the included angle between the side surface of the taper portion and the bottom surface of the taper portion is, the smaller the entire volume of the liquid dispensing container 25 is, therefore a taper portion with a suitable shape can be selected based on the tilt angle of the solar panel 200, preferably from 25 to 35 degrees.

With reference to FIG. 7, the liquid dispensing container 25 is securely disposed in the robot body of the cleaning robot 100. A central axis of the liquid dispensing container 25 is perpendicular to a bottom surface of the robot body of the cleaning robot 100. All portions of the taper portion 253 except the drainage outlet 251 are all higher than a level surface on which a center of the drainage outlet 251 is located to ensure that the drainage outlet 251 is always at the lowest point of the liquid dispensing container 25.

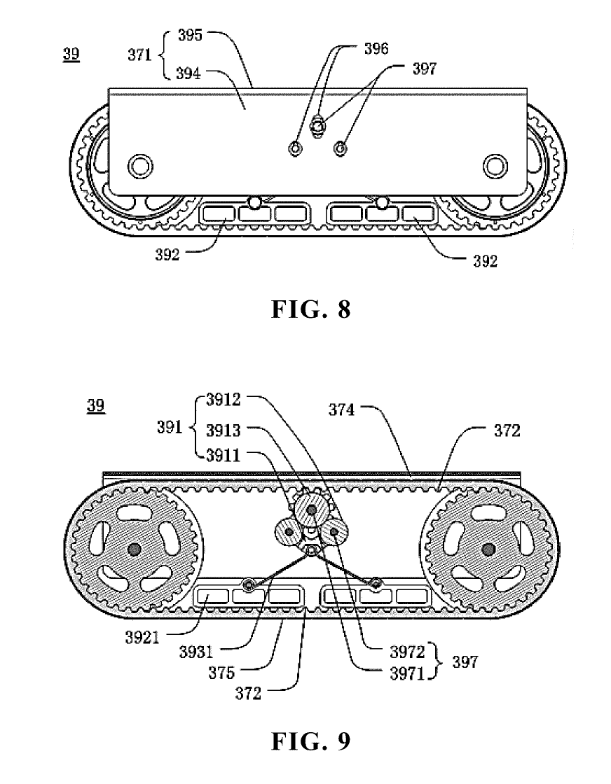

The present invention provides two solutions, one solution is as follows: With reference to FIG. 8, the column-shaped portion 252 is a prism, and the taper portion 253 is a pyramid. A pyramid-bottom-surface of the pyramid is a lower bottom surface of the prism. The present invention preferably has the prism being a rectangular prism, and the pyramid is also a rectangular pyramid. Similarly, of the prism is triangular prism, and the pyramid is also a triangular pyramid. The other solution is as follows: With reference to FIG. 9, the column-shaped portion 252 is cylinder, and the taper portion 253 is a cone. A bottom surface of the cone is a lower bottom surface of the cylinder. When the space occupied by the liquid dispensing container 25 is fixed, the capacity of the container should be increased as much as possible.

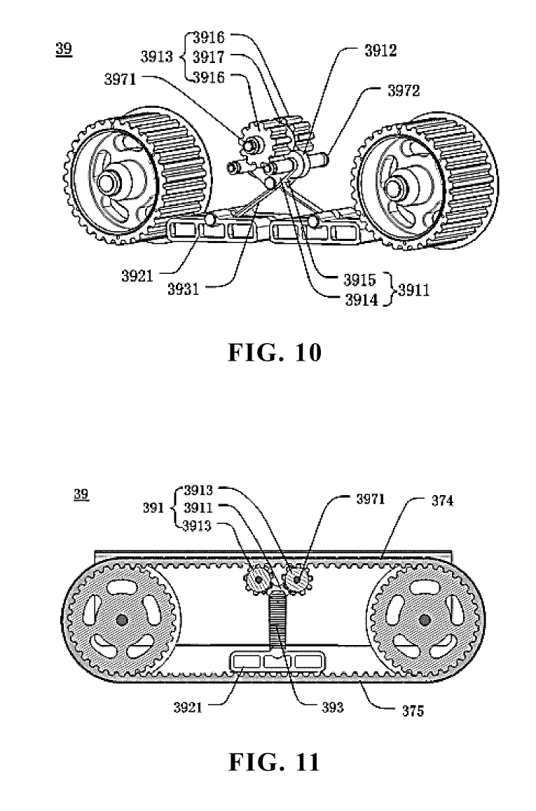

With reference to FIG. 10, the liquid dispensing container 25 of the present invention further includes a container cover 254, a fill inlet 255, a fill inlet lid 256 and a bidirectional pressure relief valve 257.

The container cover 254 is securely installed on the upper bottom surface of the column-shaped portion 252. The fill inlet 255 is disposed on the container cover 254 and extends through the container cover 254. The fill inlet lid 256 is detachably installed on the fill inlet 255 and is configured to seal the fill inlet 255. The bidirectional pressure relief valve 257 is installed through the fill inlet lid 256 and is configured to make an internal and an external of the liquid dispensing container 25 to communicate with each other such that pressures inside and outside the container 25 are balanced to allow liquid to be smoothly discharged out from the container 25.

In the present invention, a horizontal cross section of the fill inlet 255 is circular. An annular lid opening 258 is disposed on a periphery of the fill inlet 255 and is perpendicular to the container cover 254. A first thread (not shown in the figures) is disposed on an outer side surface of the annular lid opening 258. The fill inlet lid 256 is cylindrical, and a size thereof matches the fill inlet 255. A second thread (not shown in the figures) is disposed on an inner sidewall of the fill inlet lid 256. The second thread is screwed on the first thread. By engagement of the first thread and the second thread, the fill inlet lid 256 and the fill inlet 255 are detachably connected.

Liquid (water or detergent solution) stored in the liquid dispensing container 25 is consumable and needs to be supplemented regularly. After all the liquid in the container has been consumed completely, the liquid dispensing container 25 can be filled with liquid (water or detergent solution) just by unscrewing the fill inlet lid 256. A connection place of the fill inlet lid 256 and the fill inlet 255 can be further sealed by sealing liquid or a sealing element. The container cover 254 and the column-shaped portion 252 may be designed integrally as one-piece or may be designed separately, as long as the connection place between the container cover 254 and the column-shaped portion 252 and the connection portion between the filling inlet lid 256 and the filler inlet 255 are sealed well.

With reference to FIGS. 10 and 11, a liquid level sensor 259 is disposed in the liquid dispensing container 25 and is configured to acquire liquid level in the liquid dispensing container 25 in real time. The liquid level sensor 259 is a part of the control system 4. In the present invention, the liquid level sensor 259 includes a longitudinal rod 2591 and a float sensor 2592 disposed around the longitudinal rod 2591. The float sensor 2592 floats on a liquid surface in the liquid dispensing container 25, and rises and falls along the longitudinal rod 2591 according to ascent and descent of the liquid level. The longitudinal rod 2591 is located at an axis of the maximum height in the liquid dispensing container 25, and is above the central axis of the liquid dispensing container 25 such that the float sensor 2592 acquires comprehensively precise liquid levels as much as possible. A connection slot hole 2541 is disposed at a center of the container cover 254. The longitudinal rod 2591 extends through the connection slot hole 2541 and is perpendicular to the container cover 254. A disc-shaped connector 2593 is disposed on an upper end of the longitudinal rod 2591 and is securely connected to the connection slot hole 2541. A lower end of the longitudinal rod 2591 is disposed on a portion of the taper portion 253 near the drainage outlet 251. A protruding annular block 2594 is disposed on the lower end of the longitudinal rod 2591 and configured to prevent the float sensor from falling out from the longitudinal rod 2591. The float sensor is connected to other parts of the control system 4 through at least one wire 2595 extending through an internal of the longitudinal rod 2591. During work of the cleaning device, the control system 4 can transmit at least one water pump 28 control signal to the water pump 28 according to real-time liquid level data in the liquid dispensing container 25 to start or stop the operation of the water pump 28, or to control discharging speed of liquid.

In the present invention, the technical effect of the liquid dispensing container 25 is that the drainage outlet 251 is always at the lowest point of the entire container 25 regardless of the direction that the robot body 1 (or the liquid dispensing container 25) moves toward on the sloping plane 300 such that liquid stored in the container 25 may be completely discharged out for full use without liquid leakage or failure of the drainage outlet 251 discharging liquid.

In the present invention, the liquid dispensing container 25 is a sealing container as a whole, and only the drainage outlet 251 on the lowest point can discharge liquid. If the container does not have any other vent hole, under effect of atmosphere, it is difficult for liquid to discharge out of the drainage outlet 251. If the fill inlet 255 of the container maintains opened status, once the water pump 28 is opened, liquid in the container continuously flows out in acceleration, controlling the flow rate is difficult, and the liquid will therefore evaporate from the fill inlet 255. For this reason, the present invention utilizes the technical solution disposing the bidirectional pressure relief valve 257 on the fill inlet lid 256, and the pressure relief valve can be opened or closed according to variation of pressure above the liquid surface of the liquid dispensing container 25.

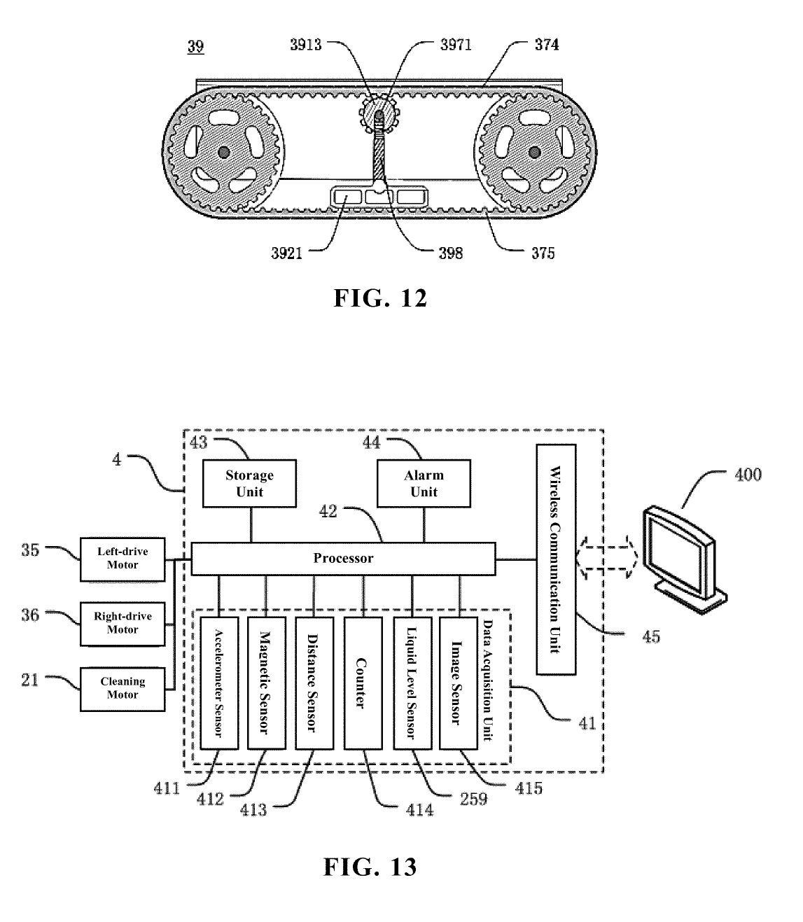

With reference to FIGS. 12 and 13, the bidirectional pressure relief valve 257 is installed through the fill inlet lid 256 and is configured to selectively communicate with an internal or an external of the liquid dispensing container 25. The bidirectional pressure relief valve 257 includes a hollow valve body 2571. A valve chamber 2572 is disposed in the valve body 2571. A sealing valve block 2573 and a sealing stopper 2574 are disposed in the valve chamber 2572.

The valve body 2571 is designed into an integral cylinder, and the valve chamber 2572 thereof is also a cylinder sealing cavity. A first vent hole 2575 is disposed on a top portion of the valve body 2571 and makes the valve chamber 2572 communicate with the external of the container 25. A second vent hole 2576 is disposed on a bottom surface of the valve body 2571 to make the valve chamber 2572 communicate with the internal of the container 25. The top portion of the valve body 2571 of the bidirectional pressure relief valve 257 is sealably connected to the fill inlet lid 256. In the present invention, the valve body 2571 and the fill inlet lid 256 may be formed integrally to one-piece to reduce manufacturing processes of parts such as disposing sealing liquid or sealing elements.

The present invention may also include a first resilient element 2577 and a second resilient element 2578. An upper end of the first resilient element 2577 is securely disposed on a top portion of the valve chamber 2572, and a lower end of the first resilient element 2577 is connected to the sealing valve block 2573. An upper end of the second resilient element 2578 is connected to the sealing valve block 2573 and a lower end of the second resilient element 2578 is securely disposed on a bottom portion of the valve chamber 2572. The sealing valve block 2573 is slidably installed in the valve chamber 2572. The sealing stopper 2574 protrudes from a middle portion of a sidewall of the valve chamber 2572. An inner sidewall of the valve chamber 2572 is a smooth sidewall. Under collective effect of the first resilient element 2577 and the second resilient element 2578, the sealing valve block 2573 can slide upward or downward. In the valve chamber 2572, the pressure above the sealing valve block 2573 is the atmospheric pressure, and the pressure below the sealing valve block 2573 is the pressure above the liquid surface of the container 25.

Specifically, the sealing valve block 2573 may include an upper section, a middle section, and a lower section, each of them is cylindrical. The sealing valve block 2573 includes an annular shoulder portion 2579 protruding from a middle portion of a sidewall of the sealing valve block 2573. The annular shoulder portion 2579 is the middle section, and the upper section and the lower section are in the same size. A diameter of a bottom surface of the annular shoulder portion 2579 (middle section) is greater than each of diameters of bottom surfaces of the upper section and the lower section. An outer sidewall of the annular shoulder portion 2579 is disposed tangentially to an outer sidewall of the sealing stopper 2574 and the inner sidewall of the valve chamber 2572. An upper portion (upper section) of the annular shoulder portion 2579 is connected to the first resilient element 2577. A lower portion (lower section) of the annular shoulder portion 2579 is connected to the second resilient element 2578. The first resilient element 2577 and the second resilient element 2578 of the present invention are preferably springs, and may choose other resilient elements.

When the water pump 28 is under stop status, the pressure above the liquid surface of the liquid dispensing container 25 is the same as the ambient atmospheric pressure. The first resilient element 2577 and the second resilient element 2578 do not deform or deforms less, the sealing valve block 2573 is in a force balance and in a relatively static status, a sidewall of a widest portion (annular shoulder portion) of the sealing valve block 2573 is disposed tangentially to a sidewall of the sealing stopper 2574 and the inner sidewall of the valve chamber 2572. The sealing valve block 2573 and sealing stopper 2574 fill a middle portion of the valve chamber 2572. An upper portion of the valve chamber 2572 is separated hermetically from a lower portion of the valve chamber 2572 without communication.

If the cleaning robot 100 is under operating status, the cleaning device 2 works normally, the water pump 28 extracts liquid, the pressure above the liquid surface in the liquid dispensing container 25 becomes smaller, the pressure in the liquid dispensing container 25 is less than the ambient atmospheric pressure, and a pressure difference is generated between an upper surface and a bottom surface of the sealing valve block 2573. The atmospheric pressure overcomes resilient force of the first resilient element 2577 and the second resilient element 2578 and gravity of the sealing valve block 2573 to make the sealing valve block 2573 slide downward. The annular shoulder portion 2579 is separated from the sealing stopper 2574, and an air passageway is formed between the annular shoulder portion 2579 and the inner sidewall of the valve chamber 2572. Under the effect of the pressure difference, ambient air enters the liquid dispensing container 25 through the air passageway. When the pressure above the liquid surface in the liquid dispensing container 25 and the ambient atmospheric pressure (pressure difference is zero) are equal or about equal (pressure difference is little), and the pressures inside and outside the liquid dispensing container 25 reach a new balance. Under effect of resilient force of the first resilient element 2577 and the second resilient element 2578, the sealing valve block 2573 slides upward progressively to further implement restoration, the sidewall of the annular shoulder portion 2579 is disposed tangentially to the sidewall of the sealing stopper 2574 and the inner sidewall of the valve chamber 2572 again, and the air passageway is closed. During operation of the cleaning device, the water pump 28 continuously extracts liquid, and the above process will be repeated. When the cleaning device stops working, or when the liquid surface in the liquid dispensing container 25 is lowered to a specific threshold value, or when remaining electric power of the electric power system 5 declines to a specific threshold value, the water pump 28 is switched off by the control system 4 and stops extracting liquid.

If the cleaning robot 100 is under stop status, the cleaning device 2 stops working, because the cleaning robot 100 is placed on the solar panel and is continuously exposed under direct sunlight in a long time, the temperature of liquid and air in the liquid dispensing container 25 may raise. Because of thermal expansion and contraction of the physical phenomenon, the pressure in the liquid dispensing container 25 would be greater than the ambient atmospheric pressure, and a pressure difference is generated between the upper surface and the bottom surface of the sealing valve block 2573 such that the sealing valve block 2573 slides upward. The annular shoulder portion 2579 and sealing stopper 2574 are separated, and an air passageway is formed between the annular shoulder portion 2579 and the inner sidewall of the valve chamber 2572. Under the effect of the pressure difference, ambient air enters the liquid dispensing container 25 through the air passageway. When the pressure above the liquid surface in the liquid dispensing container 25 and the ambient atmospheric pressure (pressure difference is zero) are equal or approximately equal (pressure difference is little), and the pressures inside and outside the liquid dispensing container 25 reach a new balance. Under effect of resilient force of the first resilient element 2577 and the second resilient element 2578, the sealing valve block 2573 slides downward progressively to further implement restoration. The sidewall of the annular shoulder portion 2579 is disposed tangentially to the sidewall of the sealing stopper 2574 and the inner sidewall of the valve chamber 2572 again, and the air passageway is closed. When the cleaning robot is under static status, the liquid dispensing container 25 is exposed under sunlight in a long time, the above process may be repeated to timely release the pressure in the container 25 to prevent safety accidents.

In the present invention, the technical effect of the bidirectional pressure relief valve 257 is that the pressures inside and outside the liquid dispensing container 25 are ensured to be maintained in a balance as much as possible such that the water pump 28 can extract liquid from the liquid dispensing container 25 or timely release the pressure in the container 25 to prevent safety accidents.

With reference to FIG. 14, in the present invention, the control system 4 includes a data acquisition unit 41, a processor 42 and at least one storage unit 43. The data acquisition unit 41 includes various sensors, and is configured to acquire at least one working parameters during the moving of the robot body 1. The processor 42 is connected to the data acquisition unit 41, transmits at least one moving control instruction to the power system 3 according to the working parameters, and transmits at least one cleaning control instruction to the cleaning device 2 according to the working parameters. The storage unit 43 is connected to the processor 42, is configured to store working parameters and other pre-calculated or preset parameters during the moving of the robot body 1. The working parameters include real-time acceleration data and real-time moving direction data of the robot body 1, real-time liquid level data of the liquid dispensing container, distance between each distance sensor and the solar panel, images in front of the robot body, etc. Pre-calculated or preset parameters include various working data predetermined by a staff member, such as a pre-calculated and pre-planned cleaning robot moving path (optimized path), a liquid level alarm threshold value in the liquid dispensing container 25 (when the threshold value is reached, the alarm unit is activated), liquid level shutdown threshold value (when the threshold value is reached, the water pump 28 stop operating), etc.

A staff member records a planned optimized path in the control system 4 in advance to provide the robot body of the cleaning robot with path navigation. The control system 4 calculates and plans according to the optimized path, and transmits various of signals of when to switch on, when to switch stop, when to move straight, when to implement left or right 90 degrees U-turn to the power system in forms of control instructions to control actions of the moving robot body.

In controlling technologies of the robot body, how to determine whether the robot body moves straight on the sloping plane or not and how to control the robot body to move straight on the sloping plane are the most basic questions. If the robot body lacks supervision during its moving on a straight line, as the robot body is deflected for some reason (for example, the road is uneven, there are obstacles on the road), the phenomenon of getting more and more deflected will occur. In the present invention, it will result in that the robot deflects from the original navigation path and cannot move through the entire sloping plane in the shortest time. In the present invention, it will result in that after the operation of the cleaning robot is completed, there are still many places on the solar panel remained uncleaned timely.

To solve the technical issue of how to determine whether the robot of the present invention moves straight on the slope, the present invention provides the following solutions.

In the control system 4, the data acquisition unit 41 includes at least one accelerometer sensor 411 configured to acquire acceleration data of the robot 100 (or the robot body 1) in real time. The accelerometer sensor 411 is connected to the processor 42 and transmits acceleration data of the robot body 1 to the processor 42. The processor 42 analyzes dynamic acceleration data and figures out the force direction and moving direction of the robot body during the moving of the robot body. The processor 42 utilizes the acceleration data of the robot 100 to build a three-dimensional coordinate system, decompose the data and calculate to define the moving direction of the robot 100 as a Y-axis direction, and to define a direction perpendicular to the sloping plane as a Z-axis direction. A plane on which the X-axis and the Y-axis are located parallels the sloping plane. According to the vectors of the acceleration data along the X-axis direction, it is determined whether the robot body 1 has left or right deflection. If deflection occurs, the processor transmits at least one direction-adjusting instruction to the power system 3 such that the robot body 1 moves back to its original straight path. If no deflection, the processor 42 determines that the robot body 1 moves straight.

Furthermore, to ensure the accuracy of determination of straight line moving, besides determination by an accelerometer sensor, a magnetic sensor technology can be utilized to make a further determination based on the determination of deflection from the original path by the accelerometer sensor, i.e. a second determination by the magnetic sensor. Thus, in the control system 4, the data acquisition unit 41 may also include a magnetic sensor 412 connected to the processor 42. The magnetic sensor 412 measures physical parameters such as current, location, direction, etc. by sensing intensity of magnetic field. In the present invention, the magnetic sensor 412 is configured to acquire moving direction data in real time and compare the acquired data with a predetermined standard moving direction based on optimized path data to make a determination to ensure whether the robot body moves straight such that the determination of whether the robot body moves straight is more accurate.

In the present invention, a method for determining whether the robot moves straight on the sloping plane and a method for controlling the robot to move straight on the sloping plane are used in conjunction with each other to ensure that the cleaning robot does not deflect during the straight moving such that the cleaning robot can be assured to be able to move through the entire solar panel in the shortest time along the preset optimized navigation path and to clean the entire solar panel fast and well.

According to the principles of the shortest time and the shortest moving path, an optimized navigation path of the robot on a rectangular slope can be easily planned and figured out. With regard to how to make the robot able to move along a preset optimized navigation path, the present invention provides a series of controlling solutions and navigation methods. The navigation method is the controlling method that making the robot move along the navigation path.

In the present invention, the data acquisition unit 41 may also include at least one distance sensor 413 including but not limited to an ultra sound sensor and an optical pulse sensor. The distance sensor 413 is disposed on an outer edge of the robot 100 (the robot body 1), and specifically can be disposed respectively on four corners of the robot body 1 (body member 11). With reference to FIG. 2, when the robot 100 moves on a rectangular slope, a front end of the distance sensor 413 faces the rectangular slope. The distance sensor 413 is connected to the processor 42 and is configured to acquire distance data of the distance sensor 413 and the rectangular slope in real time. The processor 42 determines whether the robot body 1 is located on an edge of a corner of the rectangular slope according to the distance data of the distance sensor 413 and the rectangular slope.

In the present invention, a number of the distance sensor 413 is four, and the four distance sensors 413 are disposed respectively one four corners of the robot (the robot body). When only two of the distance sensors 413 are able to acquire the distance data, the processor 42 determines that the robot (the robot body) is located on an edge of a rectangular slope 300, and transmits at least one turning instruction (U-turn) to the power system 3. When only one of the distance sensors 413 acquires the distance data, the processor 42 determines that the robot (the robot body) is located on a certain corner of the rectangular slope 300, and transmits at least one turning instruction (90 degrees turn or U-turn) to the power system 3. The four distance sensors 413 may also be disposed respectively on middle portions of four sides of the robot body 1. When finding that the distance sensor 413 on one side is unable to acquire distance data, the processor 42 may determine that the side is located on the edge of the rectangular slope. If two adjacent sides are both located on the edge of the rectangular slope, it may be determined that the robot body 1 is located on a certain corner of the solar panel. The number of the distance sensor 413 may be eight, and the eight distance sensors 413 are disposed respectively on the four corners of the robot body 1 or on the middle portions of the four sides of the robot body 1.

The control system 4 may further include a counter 414 configured to calculate corners through which the robot body 1 passes during the moving on the sloping plane. In a work of the robot, whenever the processor 42 determines that the robot body reaches a certain corner, a variable “1” is added to the counter. The processor 42, through a technical result feedbacked by the counter 414, can explicitly know an order of the corners that the robot body 1 reaches (a certain corner).

A staff member records a planned optimized path in a storage member of the control system 4 in advance. The processor transmits control instructions including start, stop, straight moving, left or right 90 degrees turn, left or right U-turn (180 degrees turn to an adjacent car lane) to the power system 3 according to the navigation path and the real-time location of the robot (robot body) to control the robot body to move based on the navigation path during the moving.

The data acquisition unit 41 further includes a liquid level sensor 259 connected to the processor 42 and configured to acquire liquid level in the liquid dispensing container 25 in real time. During work of the cleaning device, the control system 4 may transmit at least one water pump 28 control signal to the water pump 28 according to real-time liquid level data in the liquid dispensing container 25 to start or stop operation of the water pump 28, or to control discharging speed of liquid. For example, when real-time liquid level data in the liquid dispensing container 25 decreases to a predetermined threshold value, the control system 4 can transmit a water pump decelerating instruction controlling the water pump 28 to slow down water pumping speed. When real-time liquid level data in the liquid dispensing container 25 decreases to the lowest point, or, when the control system 4 transmits a robot body stopping instruction, the control system 4 can transmit a water pump stopping instruction controlling the water pump 28 to stop operation.

The control system 4 also includes at least one alarm unit 44 connected to the processor 42. The alarm unit 44 may be a red light or a buzzer disposed on the external of the robot body. When a certain working parameter exceeds the predetermined threshold value, the alarm unit transmits an alarming signal. For example, when the liquid level of the liquid dispensing container 25 is lower than a certain predetermined threshold value, or when the electric power system 5 has insufficient electric power, or when the cleaning robot transmits a malfunction signal, the alarm unit 44 may transmit an alarming signal to warn a user.

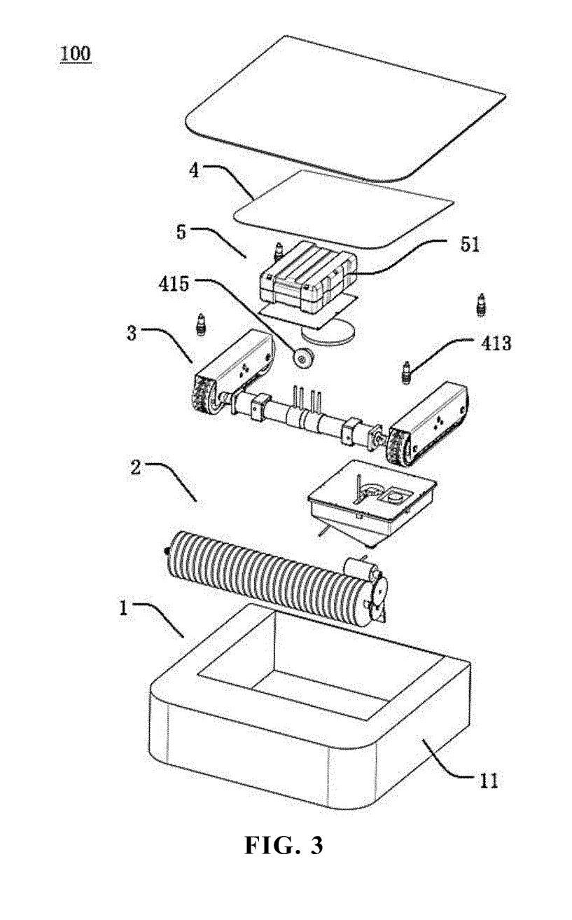

The data acquisition unit 41 includes at least one image sensor 415 or camera connected to the processor 42, disposed on the front end of the robot body 1 (with reference to FIGS. 2 and 3) and configured to acquire images in front of the robot body 1 during the moving of the robot body 1. These images can be stored in the storage unit for a staff member to check the working status of robot.

In the present invention, technical effect of the control system 4 is providing various methods for the cleaning robot to move along an optimized path on the solar panel and methods for controlling the robot to move straight on the sloping plane to ensure the robot to non-repeatedly move through the entire space of the solar panel with large coverage area without the robot falling out from an edge of the solar panel, which assures both the cleaning effect and working efficiency.

The solar panel cleaning robot 100 may also include at least one wireless communication unit 45 wirelessly connected to a server 400, and configured to build communication between the solar panel cleaning robot 100 and server 400. Images in front of the robot body 1 can be transmitted to the server 400 in real time such that a staff member may efficiently implement monitoring during the working progress of the cleaning robot, which solve the technical issue that monitoring the clean robot on the conventional solar panel becomes difficult when the solar panel is high.

In the present invention, with reference to FIG. 3, the electric power system 5 is one or a set of disposable batteries or rechargeable batteries (not shown in the figures) disposed in the battery box 51. A staff member needs to regularly remove the cleaning robot from the solar panel and replace or charge the battery therein to allow the clean robot to continue to work.

The present invention provides a solar panel cleaning robot that may freely move on the solar panel and effectively remove the dust on the panel and other attachments, and decontamination effect thereof is excellent. During operation of the cleaning robot of the present invention on the solar panel, the cleaning robot can non-repeatedly cover the entire space of the solar panel according to the preset optimized path with high working efficiency. The cleaning robot of the present invention can automatically turn or back turn according to the program to achieve automatic control and is easy to operate.

The above is only the preferred embodiment of the present invention. It should be noted that those skilled in the art, without departing from the principle of the present invention, can also make some improvements and modifications, these improvements and modifications should be deemed as the protection scope of the present invention.

What is claimed is:

1. A liquid dispensing container, comprising:
a column-shaped portion;
a taper portion having a bottom surface connected to a lower bottom surface of the column-shaped portion; and
a drainage outlet disposed on a top point of the taper portion;
wherein the liquid dispensing container is disposed on a sloping plane; an included angle between a side surface of the taper portion and the bottom surface of the taper portion is greater than or equal to an included angle between the sloping plane and a level surface.

2. The liquid dispensing container as claimed in claim 1, wherein the liquid dispensing container further comprises:
a container cover securely installed on an upper bottom surface of the column-shaped portion;
a fill inlet extending through the container cover;
a fill inlet lid detachably installed on the fill inlet; and
a bidirectional pressure relief valve installed through the fill inlet lid.

3. The liquid dispensing container as claimed in claim 1, wherein the liquid dispensing container is a sealing container.

4. The liquid dispensing container as claimed in claim 1, wherein the column-shaped portion is a cylinder, the taper portion is a cone, and a bottom surface of the cone is a lower bottom surface of the cylinder.

5. The liquid dispensing container as claimed in claim 1, wherein the column-shaped portion is a prism, the taper portion is a pyramid, a pyramid-bottom-surface of the pyramid is a lower bottom surface of the prism.

6. The liquid dispensing container as claimed in claim 1, wherein the liquid dispensing container further comprises a liquid level sensor configured to acquire liquid level information in the liquid dispensing container.

7. The liquid dispensing container as claimed in claim 1, wherein the bidirectional pressure relief valve comprises:
a valve body;
a valve chamber disposed in the valve body;
a sealing valve block slidably installed in the valve chamber; and
a sealing stopper protruding from a middle portion of an inner sidewall of the valve chamber;
wherein a sidewall of a widest portion of the sealing valve block is disposed tangentially to a sidewall of the sealing stopper and the inner sidewall of the valve chamber.

8. The liquid dispensing container as claimed in claim 7, wherein the sealing valve block comprises an annular shoulder portion protruding from a middle portion of a sidewall of the sealing valve block; and a sidewall of the annular shoulder portion is disposed tangentially to the sidewall of the sealing stopper and the inner sidewall of the valve chamber.

9. The liquid dispensing container as claimed in claim 7, wherein the bidirectional pressure relief valve further comprises:
a first vent hole disposed on a top portion of the valve body; and
a second vent hole disposed on a bottom surface of the valve body.

10. The liquid dispensing container as claimed in claim 7, wherein the bidirectional pressure relief valve further comprises:
a first resilient element having an upper end securely disposed on a top portion of the valve chamber and a lower end connected to the sealing valve block; and
a second resilient element having an upper end connected to the sealing valve block and a lower end securely disposed on a bottom portion of the valve chamber.

11. The bidirectional pressure relief valve as claimed in claim 10, wherein each of the first resilient element and the second resilient element is a spring.

12. A cleaning robot, disposed on a sloping plane, and comprising the liquid dispensing container as claimed in claim 1.
